(19) United States
(12) Patent Application Publication
(10) Pub. No.: US 2001/0024904 A1
(43) Pub. Date: Sep. 27, 2001

(54) Universal connector with integral cable management feature

(76) Inventor: Roy K. Fischer, Scottsdale, AZ (US)

Correspondence Address: Gregory J. Nelson, NELSON & ROEDIGER, Sutie 212, 3333 E. Camelback Road, Phoenix, AZ, 85018, US

(21) Appl. No.: 09/788,632

(22) Filed: Feb. 15, 2001

Related U.S. Application Data
(60) Provisional application No. 60/183,564, filed on Feb. 18, 2000.

(51) Int. Cl. H01R 13/58

(52) U.S. Cl. 439/456

(57) ABSTRACT

A connector for cable management. The connector has a housing with an electrical connector to which a cable is connected. The cable exits the housing through a slidable cursor which allows the user to direct the cable toward an interface location to reduce strain on the cable and to lessen interference and entanglement with the user and other cables and components.

This application is based on provisional application no. 60/183,564, filed Feb. 18, 2000, entitled “Universal Connector With Integral Cable Management Feature.”

### FIELD OF THE INVENTION

The present invention relates to a connector more particularly to a connector including a cable management feature that allows the cable to be directed from a point of connection to an interface location to relieve strain on the cable and to position the cable to reduce entanglement and interference.

### BACKGROUND OF THE INVENTION

Various electrical and electronic devices utilize various types of power cords, lines and cables that extend from a connector to an interface location. Typical applications are those in which a cable extends between a device such as a computer and a mouse and connections between a headset worn by the individual and a phone and other similar applications. The location of the point of connection and the interface determines the path or direction of a cable. The cable may be required to extend downwardly from the connection to the interface location or may be required to extend in an upward direction. For example, an individual carrying a cell phone in a shirt pocket using a headset, would require that the cable be directed upwardly from the cell phone to the head-worn headset. Interfaces with computers and other devices may require a cable be directed downwardly to the interface location from the connector. The cable, wire or line can be a problem as its routing may impair the user or become entangled with other cables.

### SUMMARY OF THE INVENTION

The present invention provides a universal connector housing with an integral cable management feature. The housing includes a connector which connector has a configuration required for the particular application having the proper location and number of connector pins. The cable is connected to the connector within the housing and extends through a cable trap on the housing to provide strain relief. The cable exits the housing at an opening at the rear of the housing. A cable channel extends along the rear of the housing and at least partially along one side of the housing. A cursor is slidably mounted on the housing along the channel and the cable extends through the body of the cursor. The cursor can be moved to a position to direct the cable in the desired direction to the interface location at the opposite end of the cable and to provide protection in the event of excessive tension or “pull” applied to the cable.

### BRIEF DESCRIPTION OF THE DRAWINGS

The above and other objects of the present invention will be better understood from the following description and drawings in which:

FIG. 1 is an exploded view of the connector of the present invention;

FIG. 2 is a top view of the connector with the top of the housing removed showing the inside of the housing and with the cable directed rearwardly;

FIG. 2A is a view similar to FIG. 2 with the cable being directed in a forward or upward direction;

FIGS. 3, 4 and 5 are perspective views in which the cursor has been moved in a position so that the cable exits forwardly from the housing;

FIG. 6 is a top view showing the connection with the cable directed rearwardly;

FIGS. 7 is a perspective view showing the connector with the cursor in a position to direct the cable rearwardly; and

FIG. 8 shows a cross sectional view of the cursor taken along line 8-8 of FIG. 1.

### BACKGROUND OF THE INVENTION

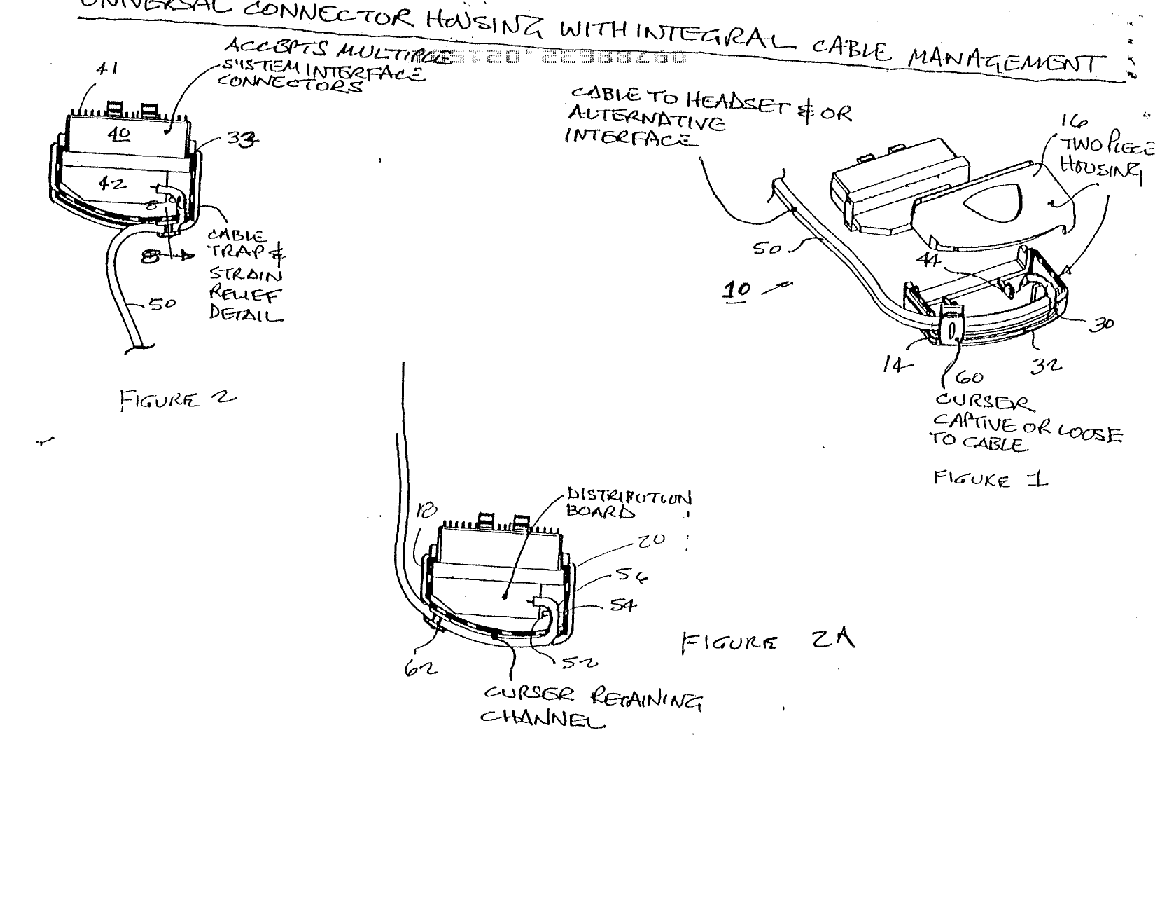

The universal connector of the present invention is generally designated by the numeral 10 and includes a two-piece housing 12 having a base 14 and upper cover 16. The housing components are preferably fabricated from a suitable plastic material by injection molding or similar techniques and may be snapped together or joined by a bonding technique. The housing, when assembled, has opposite sides 18 and 20, top wall 22, bottom wall 24 and rear wall 28. Wall 18 is shown as being shorter than wall 20. The rear wall 28 is somewhat curved or arcuate as best seen in FIGS. 1, 4 and 6. The housing 12 defines an opening 30 at a location at one end of a channel 32 formed in the rear wall 28 of the housing and which also extends at least partially along the side 18 of the housing.

The forward or front end of the housing defines an opening at 33, which is configured to receive a connector 40. The connector may be of any suitable size and configuration for the particular application. The connector shown has a plurality of pins 41 for connection to a device such as a telephone or computer. A distribution board 42 provides a contact 44 for electrical connection of the cable 50. It is noted that the term “cable” is used herein to denote any type of line, conduit or cable particularly those which are electrically conductive. The cable 50 extends from within the housing through the opening 30 in the rear of the housing and is connected as by soldering to the contact 44 on the distribution board 42.

Within the housing, adjacent opening 30, are a pair of spaced-apart posts 52, 54 which define a passageway 56 through which the cable extends. The posts 52, 54 serve to provide strain relief frictionally engaging the cable 50 so that it will not become detached from the contact on the distribution board 42 in the event tension is applied to the cable.

A slide or cursor 60 has a body 62 which defines an opening 64 which is aligned with channel 32 through which the cable passes. The opposite edges 66, 68 of the body are slidably seated within the upper end and lower edges of the cable channel 32. This detail is best seen in FIG. 8.

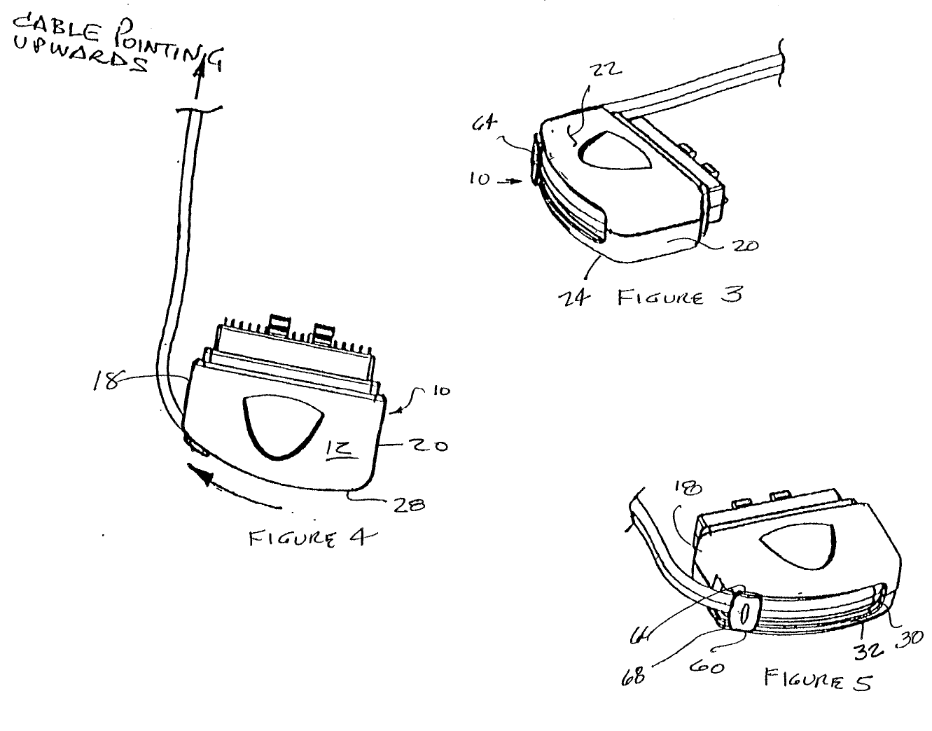

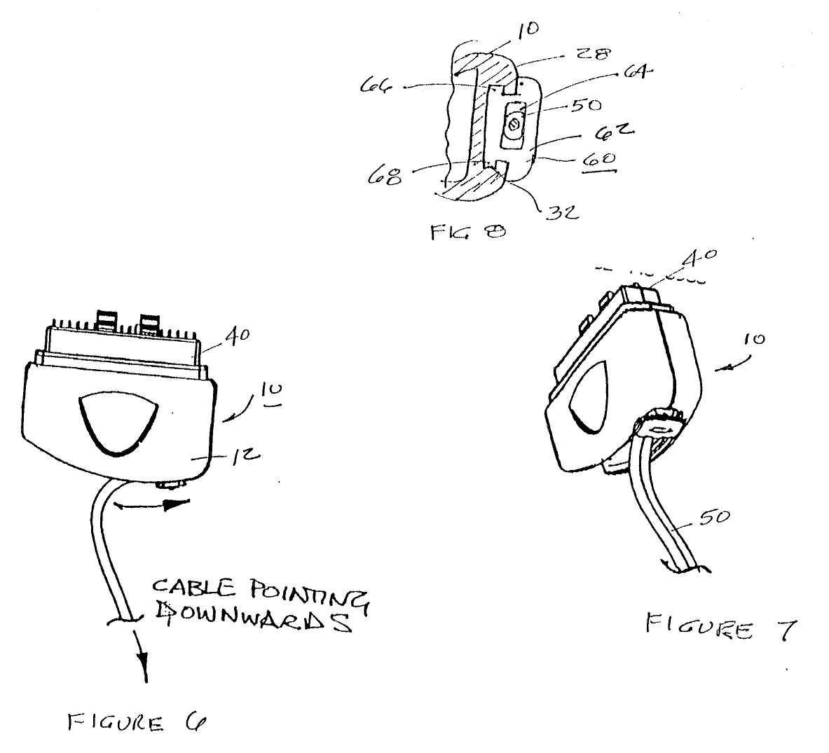

From the foregoing, it will be seen that the user may position the cursor 60 in a location along channel 32 to direct the cable upwardly or forwardly as seen in FIGS. 3 to 5 or rearwardly as seen in FIGS. 6 and 7. The cursor position shown in FIGS. 3 to 5 would be selected when the connector is used to interface between a communication device carried in a pocket and a headset. FIGS. 6 and 7 show an application such as routing a computer cable between a monitor and adjacent tower. The connector 10 allows the cursor 32 to be moved to a desired position along the channel 32 to properly direct the cable. Further, if excessive tension is placed on the cable, the cursor will tend to move or slide to the position as seen in FIG. 7 serving to provide additional cable damage protection. The posts 52, 54 will also provide resistance to inadvertent disconnection of the cable from the connector.

It will be apparent that the connector may be any required type of connector to interface with the various electrical electronic devices. Similar to the cable may be a power cable, multiple or single strand cable or single transmission cable type used in connection with computers and telephones.

It will be obvious to those skilled in the art to make various changes, alterations and modifications to the invention described herein. To the extent such changes, alterations and modifications do not depart from the spirit and scope of the appended claims, they are intended to be encompassed therein.

I claim:

1. A universal connector comprising:
(a) a housing having a body with a rear wall and having an electrical connector for attachment to an electrical device, said housing defining a cable opening for connecting a cable to said electrical connector; and
(b) a cursor moveable along said body, said cursor defining an aperture through which the cable may be directed whereby said cursor many be manually positioned with respect to said body to selectively direct the orientation of the cable relative to the housing.

2. The universal connector of claim 1 further including strain relief members associated with said housing.

3. The connector of claim 1 wherein said cursor is slidable along a curved channel extending along the said rear and a side wall of the said housing.

4. The connector of claim 1 wherein said housing comprises two section.

5. The connector of claim 2 wherein said strain relief members comprises spaced-apart members in the housing through which the cable extends.

6. The connector of claim 1 wherein said housing is injection molded.

7. The connector of claim 1 wherein said connector has a front wall, and opposite side walls, one of said walls being of greater length than the other.

8. The connector of claim 7 wherein said connector extends through said front wall.
